(19) United States
(12) Patent Application Publication
(10) Pub. No.: US 2011/0267797 A1
(43) Pub. Date: Nov. 3, 2011

(54) Device and Method for Retaining an Electrical Cord on a Motor Vehicle Exterior

(76) Inventors: Michael Clark, Winnipeg (CA); Kelly Taylor, Winnipeg (CA)

(21) Appl. No.: 13/013,204

(22) Filed: Jan. 25, 2011

Related U.S. Application Data
(60) Provisional application No. 61/330,674, filed on May 3, 2010.

(51) Int. Cl. H02B 1/01

(52) U.S. Cl. 361/825

(57) ABSTRACT

A device and method are used to retain an electrical cord on an exterior of a motor vehicle. At one or more locations along the electrical cord between opposing ends thereof, a respective pair of shell pieces are fastened together from opposite sides of the electrical cord to enclose a respective portion of the electrical cord between the respective pair of shell pieces, thereby securing the fastened-together pair of shell pieces to the electrical cord. The fastened-together shells pieces are then releasably secured to the exterior of the vehicle at a respective location thereon to secure the respective portion of the electrical cord to the exterior of the vehicle. The device of the present invention is fastened in place on the cord, not the vehicle, for the long term. Accordingly, unsightly permanent mountings on the vehicle are avoided, as is damage associate with attempted removal of permanent mountings.

### CROSS-REFERENCE TO RELATED APPLICATIONS

This application claims benefit under 35 U.S.C. 119(e) of U.S. Provisional Patent Application Ser. No. 61/330,674, filed May 3, 2010.

### FIELD OF THE INVENTION

The present invention relates to a device and method for securing an electrical cord from a block heater or other externally-powered automotive electrical device to an exterior of a vehicle.

### BACKGROUND OF THE INVENTION

In cold weather climates, it is common to use block heaters or oil pan heaters to warm engine fluids to aid in starting and warm-up of cold engines. Such devices rely on mains power and are accordingly operated by using an electrical cord to selectively connect the heater to a mains power socket. The heater's electrical cord typically exits the engine compartment proximate the grille or other suitable opening at the front end of the vehicle, and user's will typically connect a longer extension cord to the plug of the heater cord to facilitate plugging in of the heater at locations where sockets are available, but not necessarily in immediate proximity to the short built-in cord of the heater.

Prior art techniques for storing the cord during travel include disconnecting the extension cord from the heater cord, thereby allowing the extension cord to be placed in the vehicle to remain therewith for potential use at the next destination or to be left behind at the location from which the vehicle is departing for future use upon return to that location. Other users prefer to avoid the hassle of having to remove and reconnect the extension cord between trips, and so methods and devices intended to secure the cord in place during transport have been used, including extending the cord along the side of the vehicle to wrap the free plug-equipped end of the cord around the vehicle's side mirror and mounting of spools or cleats proximate the front bumper or license plate to facilitate automatic retraction or manual winding of the cord at the front of the vehicle.

With a long enough cord, the prior art technique of wrapping the cord around the side mirror of the vehicle will almost certainly obstruct the driver's view of the mirror, thus increasing the potential for an accident and thereby presenting a hazard. Also, the end of the cord may come free during travel if not wound sufficiently tight and secure, and reduced flexibility of the cord at very low temperatures may hinder the ability to achieve such tightness. Having come free, the end of the cord may be subjected to damage or wear by dragging along the ground and possibly being run over by a tire of the vehicle. Permanent mounting of a spool or cleat to the vehicle likely requires one or more of notable time, notable effort, use of tools, damage or modification to the vehicle (e.g. holes left by drilling or self-tapping fasteners) or installation by technically or mechanically trained or inclined personnel.

Another option presented in Canadian Patent Application No. 2,252,223 is a cube-shaped device incorporating sets of three holes in multiple sides thereof into which the prongs of a conventional cord plug can be inserted and retained. The device is mounted somewhere on a vehicle so that the block heater cord can be plugged into it when not in use to protect the prongs of the cord's plug. However, the device thus only retains the very end of a cable, and provides no means to support an intermediate portion thereof. Accordingly, longer cords cannot be safely secured to the vehicle exterior with this device alone, as it only supports the plug-equipped end of the cord.

Canadian Patent Application No. 2,200,668 teaches a U-shaped spring latch that is mountable on a vehicle's front bumper and allows an intermediate portion of an electrical cord to snap into and out of a secured position between legs of the latch. The latch is made of plastic, which potentially presents a problem in that plastic being worked back and forth each time the cord is inserted and removed may tend to eventually snap, especially considering that the cold weather in which the device is intended for use may contribute to an increase in the brittleness of the material. Also, while multiple latches can be used to adequately support any length of cord, the latches attach to the vehicle with adhesive or threaded fasteners, thus likely leaving behind cosmetic or structural blemishes or damage if ever removed from the vehicle.

In view of the forgoing shortcomings of the prior art, there remains a desire for improvements in retention of an electrical cord to a vehicle exterior.

### SUMMARY OF THE INVENTION

According to a first aspect of the invention there is provided a device for retaining an electrical cord on an exterior of a motor vehicle, the device comprising:

a first shell piece having a first inner side, a first outer side facing opposite the first inner side, and a first channel recessed into the first shell piece from the first inner side and extending through opposite ends of the first shell piece; and

a second shell piece having a first inner side, a second outer side facing opposite the first inner side, and a second channel recessed into the second shell piece from the second inner side and extending through opposite ends of the second shell piece, the first and second inner sides being cooperatively shaped to enable fitting of the first and second shell pieces together against one another at the first and second inner sides with the first and second channels aligned and open to one another to collectively form a resulting passage extending through the opposite ends of the first and second pieces when fitted together;

a fastener operable to secure the first and second shell pieces together when fitted against one another at the first and second inner sides with the first and second channels aligned; and

a securing element attached to the first shell piece and operable to releasably secure the first shell piece to the exterior of the motor vehicle to retain the electrical cord thereon once the shell pieces are fitted and fastened together with a portion of the electrical cable running between the shell pieces in the passage formed by the first and second channels.

The first and second shell pieces may be hingedly connected at corresponding edges of the first and second inner sides.

Preferably each channel is arcuate in cross section.

Preferably the securing element comprises a magnet.

The fastener may comprise a snap fit fastener having matable elements defined on opposing ones of the first and second shell pieces.

Preferably the first and second channels each taper in diameter moving inward from the opposite ends of the first and second shell pieces respectively.

There may be provided a sleeve fittable onto the portion of the cable to close therearound prior to fastening together of the shell pieces around the portion of the cable, the sleeve being fittable within the passage formed by the channels with the shell pieces fastened together in a secured but rotatable manner allowing rotation of the sleeve within the passage but preventing sliding of the sleeve device out from the passage.

Preferably the sleeve comprises at least one enlarged portion of greater outer diameter than a smaller diameter portion of the sleeve and the channels have channel portions of smaller radius that align with one another when the shell pieces are fastened together to define a smaller portion of the passage in which the enlarged portion of the sleeve cannot be accommodated.

The at least one enlarged portion may comprises opposing end portions of the sleeve too large to pass through respective end portions of the channels.

The channels may have corresponding enlarged portions that are of greater radius than the smaller radius portions of the channels and that align with one another when the shell pieces are fastened together to define an enlarged receiving portion of the passage, the enlarged portion of the sleeve being sized to fit within the enlarged receiving portion of the passage but not within the smaller portions of the passage.

The sleeve may comprise at least one interior projection formed at a boundary wall of an interior bore of the sleeve and projecting into the interior bore from the boundary wall.

In embodiments without the sleeve, preferably there is provided at least one projection formed at a bottom of the first or second channel to extend away from the bottom toward the first or second inner side respectively.

Preferably the at least one projection comprises a plurality of projections disposed at spaced apart positions along the first or second channel between the opposite ends thereof.

Preferably each shell piece is made of molded plastic material.

Preferably the shell pieces are shaped to, when fastened together, define a gripping feature that, relative to a contact surface of the first outer side that is intended to be secured to the vehicle, projects outward from said contact surface at a distance therefrom in a direction that separates the first inner side from the second inner side.

In use, the device is provided in combination with the electrical cord, the shell pieces being fastened together across the electrical cord to enclose the portion thereof between the shell pieces in the passage collectively defined by the channels thereof.

In further combination with the vehicle, the electrical cord may extend from proximate a front end of an engine compartment of the vehicle to a side of the vehicle where the portion of the electrical cord is retained in the device on a panel of the vehicle by the securing element. In this instance, the electrical cord, from the device, may continue away from the front end of the engine compartment and wrap around a side mirror of the vehicle.

Alternatively, the electrical cord may extend from proximate a front end of the engine compartment of the vehicle to a position on a hood of the vehicle overlying the engine compartment, where the portion of the electrical cord is retained in the device on the hood of the vehicle by the securing element.

According to a first aspect of the invention there is provided a method of retaining an electrical cord on a motor vehicle, the method comprising:

(a) at one or more locations along the electrical cord between opposing ends thereof, fastening a respective pair of shell pieces together from opposite sides of the electrical cord to enclose a respective portion of the electrical cord between the respective pair of shell pieces and thereby secure the respective fastened together pair of shell pieces to the electrical cord; and

(b) releasably securing each pair of fastened together shell pieces to an exterior of the vehicle at a respective location thereon to secure the respective portion of the electrical cord housed between the respective fastened together pair shell pieces to the exterior of the vehicle.

Step (a) may comprise securing multiple pairs of shell pieces to the electrical cord, with step (b) comprising securing the multiple pairs of shell pieces to the exterior of the vehicle.

Step (b) may comprise securing at least one pair of fastened together shell pieces to a body panel at a side of the vehicle. In this instance, the method may include wrapping part of the electrical cord about a side mirror of the vehicle, in which case the part of the electrical cord wrapped about the side mirror of the vehicle preferably does not include either of the opposing ends of the electrical cord, the wrapping of the electrical cord about the side mirror instead acting to change a direction in which the electrical cord extends along the side of the vehicle between the opposing ends of the electrical cord.

Alternatively, step (b) may comprise securing at least one pair of fastened together shell pieces to a hood of the vehicle.

Step (b) preferably comprises magnetically securing at least one pair of fastened together shell pieces to the vehicle at the exterior thereof.

### BRIEF DESCRIPTION OF THE DRAWINGS

In the accompanying drawings, which illustrate a exemplary embodiments of the present invention:

FIG. 1 is an exploded end elevational view of a two-piece cord retaining device according to a first embodiment of the present invention.

FIG. 2 is an overhead view of the first embodiment cord retaining device assembled and installed on an electrical cord.

FIG. 3 is a bottom plan view of the assembled first embodiment cord retaining device.

FIG. 4 is a bottom plan view of a top shell piece of the first embodiment cord retaining device prior to fastening thereof to a bottom shell piece to assemble the device.

FIG. 5 a cross sectional view of the assembled first embodiment cord retaining device as taken along line V-V of FIG. 3.

FIG. 6 is an exploded view of the cross section of FIG. 5, which also shows an optional additional fastener cooperating with an adhesive to secure a magnet to the bottom shell piece.

FIG. 7 is an end devotional view of a one-piece cord retaining device according to a second embodiment of the present invention.

FIG. 8 is a cross-sectional view of a modified two-piece cord retaining device according to a third embodiment of the present invention.

FIG. 9 is a schematic illustration of two cord retaining devices of the present invention in use to retain a block heater extension cord on the exterior of an automobile.

FIG. 10 is a bottom plan view of the top shell piece of a fourth embodiment cord retaining device which employs use of a sleeve fixed on the electrical cord to allow relative rotation between the assembled shell pieces and the cord.

FIG. 11 shows the electrical cord and installed sleeve of FIG. 10 in isolation from the shell pieces of the retaining device.

FIG. 12 is an exploded cross-sectional view of the sleeve of the fourth embodiment retaining device, the position of the cross-sectional plane being illustrated by line XII-XII of FIG. 11.

### DETAILED DESCRIPTION

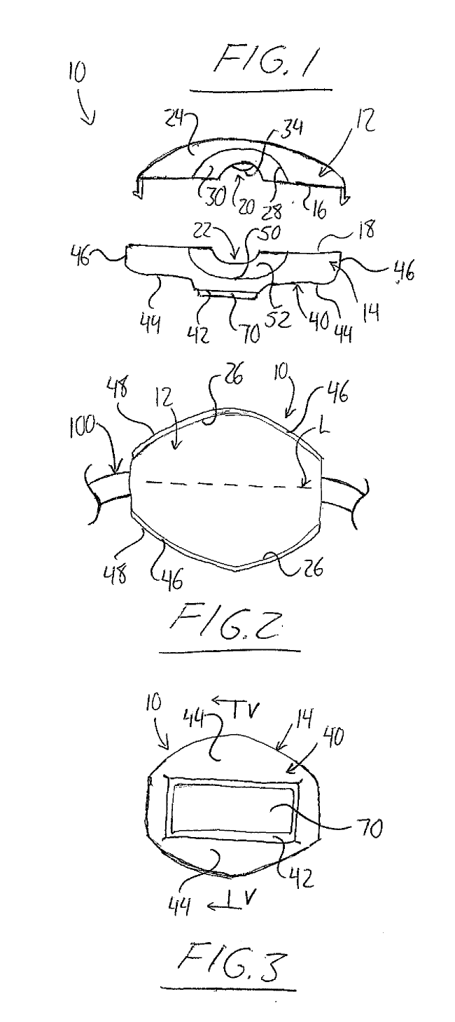

FIG. 1 shows a device 10 of a first embodiment of the present invention that is designed for use in retaining an electrical cord, such as a block heater cord or extension cord coupled to same, on the exterior of a motor vehicle. The device 10 is of a two-piece structure featuring a top shell piece 12 and a bottom shell piece 14 which are fastened together during installation on an electrical cord to in order to house and secure a portion of the cord's length between the two shell pieces, whereby that portion of the cord can subsequently be releasably attached to an exterior surface of the motor vehicle by securing the assembled shell pieces to this vehicle surface.

Each shell piece 12, 14 features a flat inner side 16, 18 lying in a respective plane so that the two inner sides 16, 18 can be placed flush against one another when the shell pieces are fastened together for assembly of the device and installation thereof on an electrical cord. Each piece 12, 14 has a respective channel 20, 22 that is recessed into it from the respective inner side 16, 18 and extends along a longitudinal axis L of the piece 12, 14 over the full length thereof from one of two opposing ends of the piece to the other. With reference to FIG. 1, the channel 20, 22 in each piece 12, 14 is semi-circular in cross section, with the recessing of the channel's bottom into the respective piece 12, 14 from the inner side 16, 18 thereof thus occurring along an arcuate path in planes normal to the longitudinal axis L shown in FIG. 2. The two channels have an equal radius so as to combine to form a conduit or passage 25 having a generally circular cross section and passing through the two shell pieces from end to end when the pieces are assembled together with their flat inner sides 16, 18 mating and their longitudinal axes aligned along the mating plane of the two pieces.

An outer side 24 of the top piece 12 facing away from the plane of the inner side 16 thereof presents a convex dome-shaped surface that is situated opposite the inner side and intersects with the inner side and the channel therein to define peripheral edges of the piece. The shape of the top piece 12 in plan is defined by these edges, which include two curved lateral edges 26 that are symmetrical across the longitudinal axis L of the piece in the plane of the inner side 16 and extend generally along a longer of the shape's two dimensions. Two end edges 28 of the piece's periphery lie in parallel planes normal to the longitudinal axis L of the piece 12 and each form a 180° arc spanning from one of the lateral edges 26 to the other due to the semi-circular shape of the channel's depth. End portions 30 of the channel 20 flare outward, increasing in radius to the respective ends of the piece 12 from a central portion 32 of the channel 20 which is uniform in radius with the exception of spaced apart locations along the central portion where bumps or ridges 34 are formed for reasons described herein further below. In the illustrated embodiments, where each piece is a unitary body of molded plastic, the outer side 24 of the top piece 12 is formed by a curved dome-shaped wall and the channel 20 is recessed into a body of material projecting from the concave side of this curved wall. To give the plastic piece strength and maintain its overall shape, a series of ribs or braces 36 is provided on each side of the channel 20 to span from the channel walls defined by the central body of material to the lateral periphery edges 26 of the outer wall over the full depth of the outer wall's concavity (i.e. from the plane of the inner side 16 opposite the outer wall to the outer wall itself). With reference to FIG. 4, the ribs of the illustrated embodiment are disposed in parallel planes normal to the longitudinal axis L at spaced positions therealong, with each rib on one side of the channel aligning with a respective rib on the other side.

An outer side 40 of the bottom piece 14 facing away from the plane of the inner side 18 thereof presents a flat planar surface 42 of rectangular shape spanning nearly the full length of the piece 14 along the longitudinal axis L but spanning only a smaller central portion of its width. This central portion 42 of the piece's outer side 40 lies in a plane parallel to that of the piece's inner side 18 at a distance therefrom in the direction defining the depth of the channel's recess into the piece. Lateral portions 44 of the bottom piece's outer side 40 flank the central portion 42 on opposite sides of the longitudinal axis L and flare laterally outward to lateral periphery walls 46 of the bottom piece that each follow a same curvature as the corresponding lateral edge 26 of the top piece 12. Each lateral periphery wall 46 interconnects the respective lateral portion 44 of the bottom piece's outer side 40 to the same piece's inner side 18 in a direction perpendicular to the parallel planes of the inner side and central portion of the outer side. Accordingly, the intersection of each lateral periphery wall 46 with the inner side 18 of the bottom piece 14 defines a respective lateral periphery edge 48 of the bottom piece 14, which follows the corresponding lateral periphery edge 26 of the top piece 12.

Like for the top piece, two end edges 50 of the bottom piece's periphery lie in parallel planes normal to the longitudinal axis L of the piece 14 and each form a 180° arc spanning from one of the lateral edges 48 to the other due to the semi-circular shape of the channel's depth. Also like the top piece, the outer shape of the bottom piece 14 in plan is defined by these peripheral edges, resulting in a shape similar to an oval or ellipse truncated at opposing ends with parallel lines normal to the long axis. Again like the top piece 12, end portions 52 of the bottom piece's channel 22 flare outward, increasing in radius to the respective ends of the piece 14 from a central portion 54 of the channel 22. The central portion 54 of the bottom piece's channel is uniform in radius, thus having a semi-circular cylindrical shape that would match that of the top channel's central portion if not for the bumps or ridges therein. In the illustrated embodiments, where each piece is a unitary body of molded plastic, the lateral portions 44 of the outer side of the bottom piece 12 and the lateral periphery walls 46 are formed by wall sections with a bend or curve between them, and the channel 22 is recessed into a body of material projecting from the flat central portion 42 of the outer side 40 toward the opposing inner side 18. To give the plastic piece strength an maintain its overall shape, a series of ribs or braces 56 is provided on each side of the channel 22 to span from the channel walls defined by the central body of material to the lateral periphery walls 46 of the outer wall over the full depth of the piece at the laterally outward portions (i.e. from the plane of the inner side 18 opposite the outer wall to the later portions 44 of the outer wall itself).

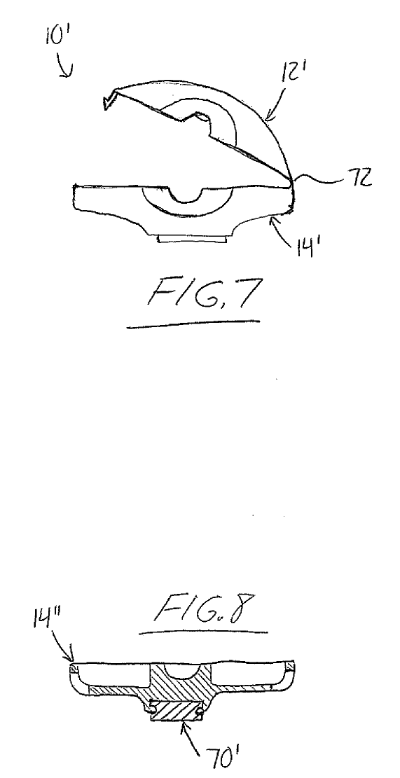

With reference to FIGS. 5 and 6, to secure the top and bottom pieces 12, 14 together when their flat inner sides 16, 18 are mated against one another with the channels 20, 22 aligned along the planes of these flat sides, the illustrated embodiment makes use of a snap fit incorporated into the molded plastic structures. At least one cantilevered tab 60 is disposed on each lateral periphery edge 26 of the top piece and features a stem portion 62 that normally projects from this peripheral edge of the inner side 16 of the piece in a direction normal to the plane of the inner side 16. A distal end of the stem portion 62 carries a generally triangular catch portion 64 that projects laterally outward from the stem portion 62 to present an upward facing ledge outward from the rest of the top piece 12, including the lateral edge 26 on which the tab is carried. At a position along the lateral periphery wall 46 of the bottom piece 14 matching the position of each tab at the corresponding lateral edge 26 of the top piece 12, a slot 66 extends upward into the lateral periphery wall 46 through where this wall and the respective lateral portion 44 of the bottom piece's outer side 44 are otherwise integrally connected. That is, the slot 66 passes through the lateral portion of the outer side and into the peripheral side wall 46 at the corner therebetween from the side of these on which the central outer side portion 42 is disposed toward the inner side of the piece.

The space separating the lateral peripheral edges 48 of the bottom piece 14 across the longitudinal axis L slightly exceeds that separating the lateral peripheral edges 26 of the top piece so that, referring to FIG. 6, lowering the inner side 16 of the top piece down toward the facing inner side 18 of the bottom piece to bring the two together into mating contact will engage the downwardly and outwardly facing obliquely sloped face of the tab's catch portion 64 against the upward facing lateral peripheral edge 48 of the bottom piece 14, forcing the resilient stem 62 of the tab 60 to flex inward. Continued downward motion of the top piece's inner side 16 onto the bottom piece's inner side 18 thus flexes the resilient tabs inward enough to allow the catch portion to clear the edge 48 at the top of the lateral wall 46 and slide downward along the intact upper portion thereof to reach the slot 66. When the ledge of the catch portion 64 reaches the slot 66, the resiliency of the stem portion 62 biases the tab back into its normal default bias position projecting normally from the inner side of the top piece, which forces the ledge of the catch portion into the slot 66. This fastens the two pieces together at the side on which this tab is located by blocking withdrawal of the top piece from off the bottom piece through contact of the catch tab's ledge with the top of the slot. Likewise, this forcing together of the two pieces into the mating condition placing the inners sides together also engages any and all other tab/slot pairings arranged at other positions along the peripheries of the pieces.

With reference to FIGS. 1 and 2, the cord retaining device 10 is installed on an electrical cord 100 by positioning the two shell pieces 12, 14 on opposite sides of a portion of the cord's length with the inner sides of the two pieces facing one another with the cord positioned between them. With the portion of the cord laid straight, for example by laying it within the channel of one of the two shell pieces, the channels of the shell pieces are aligned with one another and with the straight portion of the cord's length. The flat inner sides of the two shell pieces are brought together at a plane containing the central axis of the straight portion of cord. This fastens the two shell pieces together, as described above, and accordingly secures the two shell pieces together around the portion of the cord now disposed within the conduit or passage defined by the cooperation of the two channels that now open into one another between the two shell pieces. This fastening together of the shell pieces into an assembled state on the cord thus secures the cord retaining device to the cord, and vice versa.

The radius of the central portions of the channels is selected such that the resulting central portion of the passage through the assembled pieces slightly exceeds the outer diameter of a conventionally sized electrical extension cord to allow easy placement of the cord into one of the channels. The passage diameter is less than the plug or socket body at each end of the conventionally sized extension cord, and thus the device cannot be slid off the end of the cord once installed on an intermediate portion thereof between the so-equipped cord ends.

However, it will be appreciated that full securing of a cable on a vehicle exterior may additionally require resisting relative sliding between the electrical cord and the retaining device to be secured to the vehicle, as such sliding may introduce slack in the cord which can free itself from adjacent the exterior surface of the vehicle. The aforementioned bumps or ridges 34 in the channel 20 of the top piece 12 thus aid in fixing the position of the device 10 on the cord once installed by preventing or resisting sliding therebetween. The bumps or ridges 34 project from the bottom of the channel 20 toward the inner side of the top piece 12 by a short distance less than the depth by which the rest of the central portion of the channel recesses into the piece from the inner side thereof. Accordingly, when the shell pieces are fastened together across the portion of the cord between them, this cord portion is snuggly pinched between each bump or ridge 34 and the opposing arcuate bottom of the channel in the bottom piece.

Giving these projections on the channel bottom a curved or rounded face as opposed to flat surfaces avoids edges on the projections that may otherwise bite into the insulation layer of the cord too aggressively and potentially cause damage. Knowing conventional or standard electrical cord dimensions and specifications, the size of the channel's central portion and frictional gripping bumps or ridges therein can be selected to balance a desirable degree of sliding resistance on the cord with the need to avoid potential damage to the cord.

The flared end portions of the channels, where the channel size tapers moving inward from the ends of the shell pieces to the cord-gripping central portion of the resulting passage through the assembled shells, increase relative flexibility between the cord and the retaining device installed thereon at the exit of the cord from the device, thereby reducing the potential for kinking, fraying or other damage compared to alternate embodiments in which the cord exits at a tighter fitting end of the retaining device.

With one or more of the device 10 now installed on an electrical cord 100 intended for automotive use, such as the cord of a block heater, oil pan heater or interior warmer or an extension cord into which such a device is plugged, the cord can be strung along a desired path along an exterior of the vehicle and secured in place along such a path by the device(s) at one or more positions along this path. In the illustrated embodiments, the device uses a magnet situated at the flat central portion of the outer side of the bottom piece to achieve a releasable connection of the assembled shell pieces to the vehicle. Accordingly, each device can be used to support a respective portion of the cord at a location of magnetically attractable material on the vehicle.

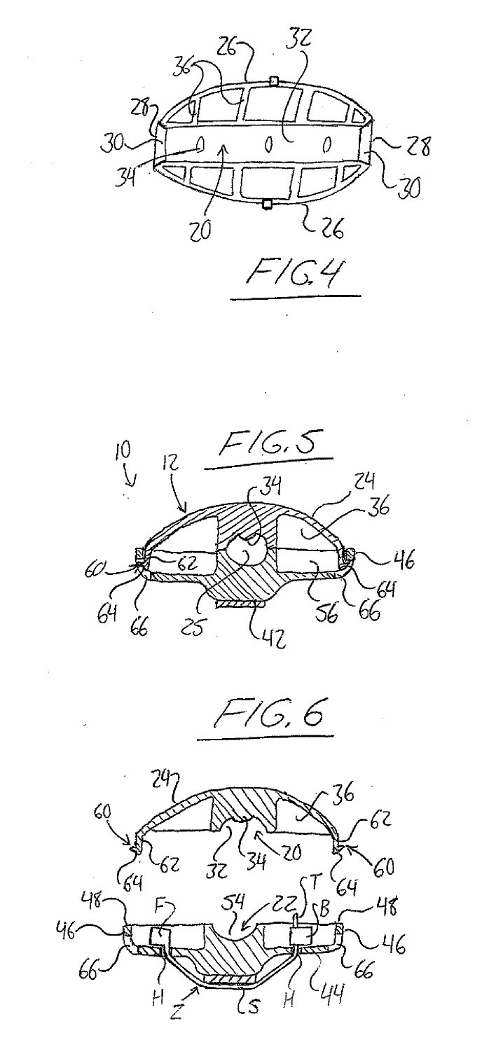

The first embodiment of FIGS. 1 to 6 features a flat plate-shaped magnet 70 lying entirely exterior to the bottom shell piece and mounted to sit flat against the central portion 42 of the outer side 40 by adhesive or other fastening thereto. The magnet 70 is illustrated as having a rectangular shape occupying nearly the full rectangular area of the central portion 42 of the outer side 40 of the bottom piece 14, but it will be appreciated that the size and shape of the magnet may vary so long as its magnetic field is sufficiently strong to secure the device in place when used. While the use of ferromagnetic materials in automobile construction has been reduced from what it once was, conventional vehicles will still often contain suitable sites for magnetic mounting of one or more of the cord retaining devices. For example, galvanized steel is still the material of choice for hoods and fenders of vehicles owing to its advantages relating to strength and weight.

FIG. 6 shows use of a conventional zip tie Z to cooperate with the adhesive connection of the magnet 70 to the underside of the bottom shell to better retain the magnet thereon. On each side of the bottom pieces central portion 42, a hole H in the respective lateral portion 44 is large enough to accommodate passage of the zip ties serrated strip S through the hole H, but small enough to block passage of the fastener head F of the zip tie Z through the hole H. Prior to assembling the shell pieces together, the zip tie strip S is passed through one of the holes H from the inner side of the bottom shell piece to seat the zip tie fastener head F against the lateral portion 44 at the perimeter of the hole H. From this first hole, the zip tie strip S crosses beneath the central portion 42, and the magnet 70 thereon, and passes back upward through the hole in other lateral portion 44. This tail T or free end of the strip passing back up toward the inner side for the bottom shell piece then has the fastener block B engaged thereto, and the tail end T of the strip S is pulled through the block B to tighten the strip S up against the magnet 70, clamping it against the bottom central portion 42 of the shell piece. This tightening of the strip S forces the fastening block B against the respective lateral portion of the shell at the perimeter of the hole therein. The fastener head F and end block B thus maintain the tightened condition of the strip S, which in turn contributes to the also adhesively-based securing of the magnet to the shell piece. When used, the described two-hole and zip tie fastener combination is provided at two or more locations along the length of the magnet 70. It will be appreciated that such zip-tie fastening may be employed without use of adhesive, or in combination with another mounting type. For ease of illustration, the zip tie strip is shown schematically, without explicit illustration of its serrations that cooperate with a fastener block in a known manner.

The magnet may have a different shape from the flat bar shape shown in FIG. 6, for example having an underside shaped to accommodate the zip ties in a manner where they do not interfere with contact of the magnet with the vehicle. That is, one or more grooves extending across the magnet could receive the zip ties in a position recessed from the a bottom surface of the magnet on opposite sides of each groove, or the magnet could feature projections extending downward at positions where the zip ties aren't crossing that magnet, so that these projections define the contact points with the car. In embodiments where zip ties aren't used, a rubber gasket may snap fit onto the bottom shell pieces around the perimeter of the magnet or otherwise engage the combined magnet and shell piece to provide a thin rubber buffer around the perimeter of the magnet. This rubber gasket would be the only part to actually contact the vehicle when the device is magnetically held thereagainst, the flexible rubber thereby avoiding scratching of the vehicle surface finish that might otherwise occur under direct contact between the magnet and the vehicle.

FIG. 7 shows a second embodiment device 10′ that differs from the first embodiment device 10 in that the top and bottom pieces 12′, 14′ are not entirely separate from one another prior to their fastening together by one or more latching tab and slot combinations. Instead, the two pieces 12′, 14′ are molded together as a unitary construction in which the two shell pieces are integrally connected by a live hinge 72 provided by a thin flexible plastic connection between the two lateral peripheral edges of the two pieces at one side thereof. This hinged-together lateral side of the pieces thus lacks the respective tab and slot combination of the two-piece device first embodiment, and so one or more pairs of a tab and slot are only provided at the other lateral side of the pieces opposite the hinge connection. To install the second embodiment device 10′ on an electrical cable, the portion of the cable to be secured in the device is inserted into a position between the shells through the unhinged side thereof to lie along the channels in the shells. With the cable portion positioned to sit in one of the channels, the unhinged side of the shells is closed to bring the flat inner sides of the shells together against one another, thus achieving the locking engagement of the shells together by cooperation of the one or more tabs on the unhinged side with the respective slot(s). With the shells fastened together, the device then functions in the same manner as the first embodiment.

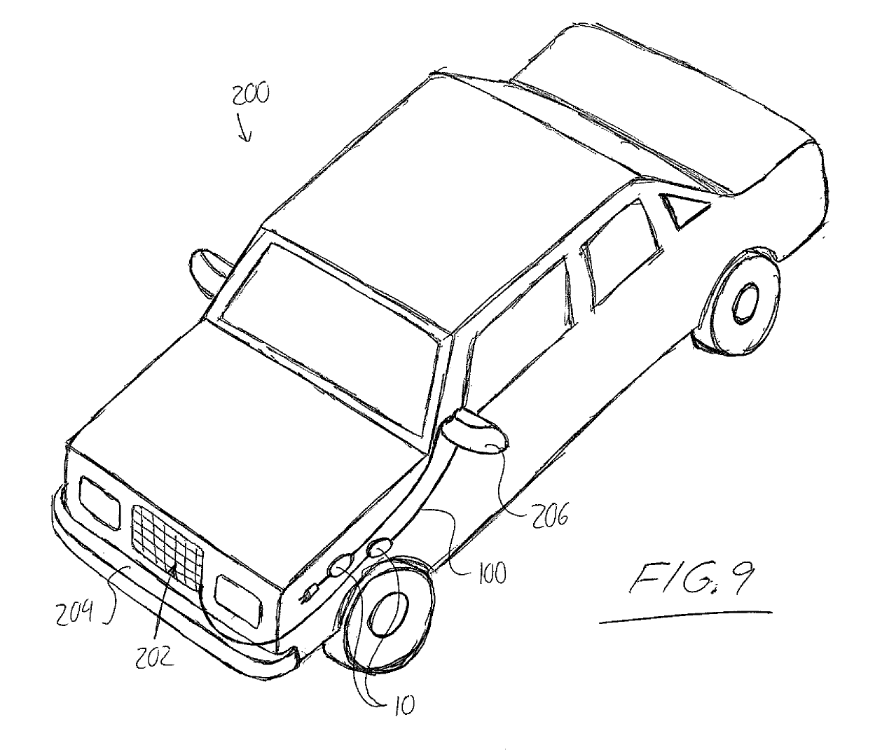

FIG. 8 shows the bottom shell piece 14″ of a third embodiment device 10″ which differs from the first embodiment only in the shape and mounting of the magnet 70′. In this embodiment, the magnet is built into the shell piece by having molded it in place during production of the shell piece. The cross-section of the magnet in a plane normal to the longitudinal axis has a top portion embedded within the bottom shell piece above the central exterior surface of the outer side thereof. From this top portion, the magnet 70′ narrows in width where it passes through the central portion of the outer side of the piece to present a bottom face of the magnet 70′ a short distance outward from the exterior surface of this central portion of the outer side. As shown in the figure, the magnet may widen again from the narrow portion transitioning from inside to outside the shell piece to the bottom portion external to the shell piece. The bottom end of the magnet is thus situated in the same position as that of the first embodiment so as to lie along the exterior of the central portion of the shell piece's outer side. In another embodiment, not illustrated, the magnet may instead be entirely embedded within the shell piece so that the device contacts the vehicle surface directly at the central outer face of the shell piece instead of at the face of a magnet situated outwardly adjacent the outer face of the shell piece, in which case the magnetic field of the magnet would act through the plastic defining the outer surface of this part of the shell to magnetically engage the shell to the vehicle. Another embodiment may have the magnet bottom exposed at and flush with the bottom of the shell piece.

FIG. 9 illustrates use of a pair of retaining devices 10 used to secure an extension cord 100 in a fixed position on an exterior of a vehicle 200 to facilitate safe transfer of the cord 100 during travel of the vehicle without requiring disconnection of the extension cord from the cord of the block heater or other externally-powered electrical device of the vehicle. The extension cord 100, or the block heater cord to which it is coupled, exits the engine compartment of the vehicle through an opening at a front end thereof, such as provided by or adjacent the vehicle grille 202. From here, the extension cord 100 is laid out along an exterior of the vehicle, and the two retaining devices 10 having been previously installed on the cable are used to secure two distinct points along the cable's length to the vehicle exterior.

In the figure, the cord has been laid out to extend from above the bumper 204 at the front of the vehicle around a front corner and rearward to a respective one of the vehicle's exterior side mirrors. 206, where an intermediate portion of the cord between the ends thereof is wrapped less than one full turn or winding around the mirror support projecting outwardly away from the passenger cabin of the vehicle to reverse the cord's direction along the side of the vehicle. One of the two retaining devices 10 secures a portion of the cord extending rearward from the vehicle's front end toward the side mirror to an exterior body panel at a location adjacent the front wheel well on this side of the vehicle. The other of the two devices 10 retains a portion of the cord extending forward from the mirror back toward the front end at a similar location proximate the same front wheel well. The magnet will attach to the vehicle fender above the wheel well, which in the vast majority of vehicles on the road today and planned for future production consists of painted galvanized steel.

It will be appreciated that the arrangement of FIG. 9 is shown only as one possible example of where one or more retaining devices may be secured to a vehicle to carry an electrical cord externally thereon. This example features a relatively long extension cord, and thus makes use of the side mirror as a turn-around or redirection point to make multiple runs along the side of the car below the hood-line thereof. A shorter cord may be laid out also on the side of the vehicle, but make only a single pass therealong if insufficient to reach the mirror. Alternatively, a cord retained with more than one retaining device may change direction along the vehicle exterior without wrapping about the side mirror or even about some other projecting feature on the vehicle. The example of wrapping about the mirror is presented as an option because it is in accordance with an existing practice of using the mirror as a cord-anchoring feature, and accordingly fits in with habits of those who already practice the existing mirror-wrapping method, but the additional use of the retaining devices in combination with the mirror reduces the required number of turns or windings of the cord around the mirror in order to securely position it on the vehicle, thereby reducing the degree of sight-line obstruction from the driver's seat of the vehicle to the side mirror. For example, on most if not all vehicles, the approximately-half of a single winding of the cord around the mirror of FIG. 9 will not obstruct the mirror at all.

As an alternative or additional anchoring point to the vehicle, the cord may be laid out on the hood of the vehicle over what is typically the engine compartment thereof with one or more devices installed on the cord and magnetically engaged to the hood itself, provided that the hood construction includes use of a magnetically attractable material.

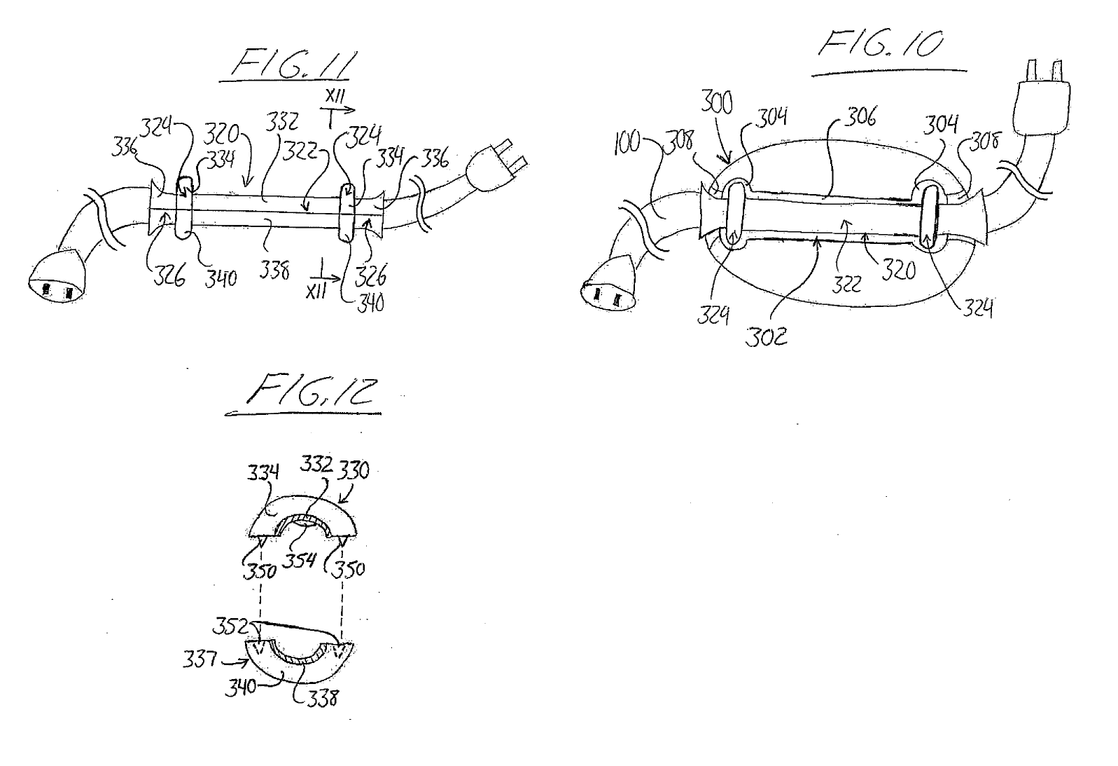

FIGS. 10 to 12 show components of a fourth embodiment device that differs from the other embodiments in that the shell pieces do not snuggly embrace the electrical cord extending through the passage between them when the device is installed on the cord. Instead, the channels in the shell pieces are larger and each lack any bumps, ridges, nodules or other cord-gripping features so that the cord is free to rotate relative to the shells within the passage defined between them. This way, in very low outdoor temperatures where electrical cords may tend to stiffen and be harder to manipulate, a user can simply rotate the fastened-together shell pieces about the axis of the passage around the portion of the cord running between them in order to face the magnet of the device toward the exterior vehicle surface, instead of having to twist the portion of the cord on which the device was installed against the increased resistance to such twisting in extreme low temperature conditions.

However, as mentioned above for the other embodiments, secure stowage of the cord on the vehicle exterior likely requires providing resistance to relative sliding between the cord and the device along the axis of the passage therethrough, and a loose fit between the cord and shells pieces that would allow relative rotation between them would likewise allow relative axial sliding between them. Accordingly, the fourth embodiment device employs an additional aspect in the form of an internal sleeve structure that fits onto the cord in a slide-resisting manner like the shells of the other illustrated embodiments, and then is in turn enclosed between the shell pieces in a rotation-allowing but slide-blocking manner. The sleeve and the cord on which it is fixed can thus rotate between the shells to allow relative rotation of the assembled shells around them to reorient the magnet around the cord axis without having to twist the cord itself.

FIG. 10 shows the underside of a top piece 300 of the fourth embodiment, which features channel 302 that is larger in radius than the top channel of the other embodiments at all points therealong, but otherwise only differs in the lack of any bumps or ridges at its bottom and the addition of two enlarged portions 304 at the two transitions from the uniform central portion 306 to the flared end portions 308. Other than the channel shape and configuration, details of the top piece's underside have been omitted from FIG. 10 for ease of illustration. Although not shown, the channel in the bottom piece of the fourth embodiment may be of the same configuration as the channel 302 of the top piece 300 so that when the two pieces are mated together and fastened at their inner sides, each enlarged portion 304 of the upper channel aligns with and opens into a respective enlarged portion of the lower channel and the uniform central portion 306 of the upper channel aligns with and opens into that of the lower channel. With no bumps or ridges, the wall of each channel is of a smooth, semicircular arcuate shape that has a greater radius at the enlarged portions 304 than at the central portion 306 between them. The passage resulting from the assembly of the shell pieces together is thus circular in cross section and has a uniform central portion of a first diameter, two enlarged portions of a diameter larger than the first at opposite ends of the central portion, and two flared end portions adjacently and respectively outward of the two enlarged portions.

When assembled and installed on an electrical cord 100, the sleeve 320 of the fourth embodiment has an external shape corresponding to the shape of the passage through the shells. That is, the sleeve 320 features a central portion 322 of uniform cylindrical shape, two enlarged portions 324 of larger outer diameter than the central portion 322 at opposite ends thereof, and two flared end portions 326 defining opposed ends of the sleeve 320 outside the two enlarged portions 324. With reference to FIG. 10, so that the sleeve 320 is free to rotate within the passage about the axis of the cord inside the sleeve, the outer diameter of the sleeve's enlarged portions 324 is slightly less than the diameter of the passage's enlarged portions, the outer diameter of the sleeve's central portion 322 is likewise slightly less than the diameter of the passage's central portion, and the flare of the sleeve's end portions 326 follows that of the passage's end portions but at a short distance inward therefrom. Accordingly, with the sleeve laid within the channel of one of the shell pieces to extend axially therealong and the other shell piece then fastened to the first shell piece to enclose the sleeve between them within the resulting passage defined by cooperation of the channels, space is left between the sleeve and the channel/passage boundary walls at all points therealong to minimize frictional contact between the sleeve and passage walls and thereby allow relative rotation between the sleeve and shells with minimal effort. However, axial sliding of the fixed-together cord and sleeve along the channel is prevented or limited by contact between the enlarged sleeve portions 304 and the boundaries between the enlarged passage portions the central passage portion because the outer diameter of the sleeve's enlarged portions 304 exceeds the diameter of the central portion of the passage. Accordingly, each enlarged portion 304 of the sleeve cooperates with the respective enlarged portion of the passage to block sliding of this enlarged portion toward the opposite end of the assembled shells to present sliding of the sleeve out from between the shells.

With reference to FIG. 12, the illustrated sleeve is of a two-piece construction that is assembled onto the electrical cord 100 in a manner similar to the shell pieces of the first embodiment device. A first piece 330 of the sleeve has a central semi-cylindrical wall 332 extending along the axis about which it curves. At or near each end of this wall 332 a semi-annular flange 334 projects radially out from the semi-cylindrical wall 332 and terminates its 180° arcuate span at the same axial plane as the wall. From each end of the semi-cylindrical wall 332, an end wall segment 336 continues along the axial direction to the respective end of the piece and terminates its 180° arcuate span in the same axial plane, but smoothly and gradually increases in radius moving toward this respective end. The second sleeve piece 337 has these same features in the same configuration, namely a central semi-cylindrical wall 338 between two semi-annular flanges 340 and two end wall segment 342. The two pieces are matable together at their axial planes from opposite sides of a portion of the electrical cord 100 to close the sleeve therearound. Brought together in this manner with each flange aligned with a respective one of the other piece's flanges, the semi-cylindrical walls 332, 338 of the two sleeve pieces collectively form the cylindrical central portion 322 of the sleeve closing around the cord, the flanges define the enlarged annular sleeve portions 324 projecting further outward from the cord, and the end wall segments define the flared end portions of the sleeve.

With reference to FIG. 12, the two pieces of the sleeve assembly may have matable features defined on opposing ones thereof to at aligned axial positions along the pieces and aligned radial distances outward from the central axes thereof to act as alignment guides in fitting together the two pieces. The figure shows a pair of projections 350 on the flange 334 of the first piece at positions extending perpendicularly outward from the axial plane of the coplanar terminal edges of the flange, with a pair of corresponding holes or recesses 352 extending into the coplanar terminal flange edges of the corresponding flange in directions perpendicular to the plane of these edges. The projections and recesses, shaped for cooperable insertion of the projections into the recesses, thus serve as guides to ensure proper alignment of the two pieces when brought together. As shown, the projections may taper moving away from the piece on which they're carried and the recesses may correspondingly taper moving into the other piece to allow smooth, easy insertion of the projections into the slots. As also shown in FIG. 12, nodules 354 like the bumps or ridges of the shell pieces of the other embodiments may be provided at spaced positions along the concave inner bottom of the semi-cylindrical wall 332 of one of the sleeve pieces to grip the outer insulation of the electrical cord 100 when the sleeve pieces are fastened together thereacross so in order to likewise resist sliding of the sleeve along the cord.

The sleeve pieces 330, 337 are preferably plastic molded, like the shell pieces, and accordingly may employ integral snap fit features (not shown) to securely fasten them together for installation on the electrical cord. In such instance, separate alignment guides 350, 352 may not be necessary, as the locking snaps may serve to both guide the mating of the pieces and achieve the fastening together thereof. One example of an alternate fastening together of the sleeve pieces would be two wrap a length of adhesive tape around it, preferably at the cylindrical central portion of the sleeve. Such length of tape would be preferably be a minimal amount selected to be long enough to encircle around the sleeve at least the one or more times necessary for sufficient strength, but short enough not to increase the diameter of the sleeve to a point where it's no longer easily rotatable in the shell pieces when installation of the retaining device is completed. With the sleeve secured on the cord in a sufficiently tight manner to resist non-manual sliding therebetween and the shell pieces subsequently fitted together over the installed sleeve, the shape of the sleeve cooperates with the shape of the assembled shell pieces to prevent sliding of the sleeve out from between the shells and thus prevent undesirable sliding of the entire retaining device along the cord when in use on a vehicle exterior. The swivel sleeve alleviates alignment issues with the magnetic base of the shell assembly to the vehicle. Also, the magnetic attraction of the base shell to the magnetically attractable material of the vehicle may eliminate any need to manually twist the shell assembly to align with the vehicle surface, as the magnetic attraction alone upon bringing the retaining device into proximity to the vehicle may be sufficient to rotate the magnetic base around the cord axis.

The bore through the assembled sleeve is cylindrical over its central portion, but flares outward (tapers inward) at its end portions for the same reasons described above for the similar flaring (or tapering) of the channel ends in the sleeveless embodiments. With reference to FIG. 10, sleeves that flare outward at their ends, whether in a similarly flared end portion of the channel or at locations external to the shells, may not require separate enlarged portions of the sleeve periphery inside the shells if the largest diameter at these flared portions of the sleeve exceeds the diameter of the passage through the shells proximate the ends thereof, as each such flared sleeve end would block pulling of the sleeve out through the opposite end of the shell by contact of the flared end with the respective end of the assembled shell pieces. In other words, enlarged portions (flared or otherwise) need not necessarily be positioned internally within the shell assembly, as a pair of enlarged end portions of a sleeve that exceeds the shell length may perform a slide-stop function at the exterior of the shells. An alternate embodiment employing a shell interior slide-stopping configuration may use a number of enlarged sleeve portions other than the two internal enlargements illustrated. For example, a single such enlarged sleeve portion and single respective enlarged portion of the passage inside the shells, preferably centered along the sleeve and passage respectively, would block sliding in both axial directions if the passage features smaller-diameter portions on both sides of the enlarged portion. Although the illustrated shell pieces are initially separated entirely, an alternate embodiment may employ a hinged configuration in which the pieces are joined by a pivotal connection along one side.

The retaining device of the present invention differs from the prior art devices described in the background above in that the device is fastened in place on the cord for the long term, not the vehicle. In the prior art, the devices are installed permanently, or at least for the winter season, on the vehicle and the cord is attached to and detached from the device every time the cord is switched between a storage position on the vehicle and an in-use position plugging in the electrical device. In the present invention, the device fastens onto the cord once and can be left thereon for the entire winter season or the full lifespan of the cord, and the magnet acts as a releasable securing element that can be repeatedly secured to and removed from the vehicle body without damage to the exterior finish thereof. With no permanent mounting of any parts required on the vehicle, no modification to the vehicle is required and any consumer can use the present invention regardless of technical or mechanical know-how or ability.

Since the device only requires a one-time installation on the cord, no repeated flexing of fastener elements is required during use. Accordingly, the device can be installed on a cord in warm or moderate temperatures, for example above the freezing point, indoors at any time of year or before the start of a cold weather season to avoid the risk of snapping plastic fastener elements during attempted actuation thereof in extremely cold temperatures where the normally pliable plastic becomes brittle. While some embodiments may employ releasable fasteners allowing reopening or separation of the two shells (and possibly also on the sleeve halves in sleeve-equipped embodiments) after assembly on a cord, others may intended for permanent fastening and thus require purchase of a retaining device or set of retaining devices when a new cord is to be used.

The illustrated snap fit tabs and slots are located at peripheral edges with tabs catches situated entirely outward from the rest of the piece and slots cutting into the other pieces from beneath to simplify the mold complexity, and only two tabs and two slots are shown for ease of illustration, but snap fits of other types, numbers and positions may alternatively be employed. In other embodiments where the catches of the latching tabs are not disposed outward from the rest of the tab-equipped shell, the two shells may be sized to align their lateral side edges. If the single tab at the lengthwise center of each elongated lateral side of the shell is insufficient to hold the shells tight enough together to sufficiently grip the cord, two or more tabs at spaced positions along the length of the respective side of the shell may alternatively be used. Preferably the tightness with which the cord is gripped between the shells or sleeve pieces is loose enough to allow sliding of the device along the cord when manually pulled with suitable force for selective repositioning thereof along the length of the cord, while tight enough not to allow such relative sliding when the cord is hanging or subjected to the elements (wind, snow, sleet, etc.) on the moving or stationary vehicle. It may be possible to achieve suitable closing tightness of the shells or sleeve pieces on the cord without the bumps, ridges or nodules projecting from a channel boundary or sleeve wall. It will also be appreciated that fastening arrangements other than the cantilevered snap fit described herein may be employed to secure the shells together for installation on a cord. Molded in place snap fits have the advantage of avoiding fastener elements separate from the shells to avoid the potential for loss of separate components.

The number, size and shape of magnets used may be altered, just as aspects of the size and shape of the shells may be varied. For example, the lateral sides need not necessarily be curved, the outer surface of the top piece need not be domed and the outer surface of the bottom piece need not be of the described multi-level shape presenting laterally outward projecting surfaces by which a user's fingers can be inserted between the vehicle and these surfaces to pry or pull the device out its magnetic engagement with the vehicle. Such gripping features may be provided elsewhere, even on the opposite shell, by other elements projecting outward past the shell surface to be secured to the vehicle surface by the magnet at a distance from this contact surface of the shell. The device also need not necessarily have an elongated shape in the direction in which the cord is to pass through the fastened-together shells in order to securely retain a short portion of the cord's overall length. Also, the channels and resulting passage need not necessarily be arcuate and circular in cross section respectively to firmly grip an electrical cord, and the mating inner sides need not necessarily be flat to mate together against one another. Likewise, the shell passage and sleeve exterior need not necessarily both be circular to allow rotation therebetween, but use of two straight-sided cross-sections should ideally be avoided to avoiding rotational jamming. The channel walls or boundaries need not necessarily be continuous from end to end, as the cord need not be fully enclosed or surrounded on all sides over the full length thereof. Although plastic is preferred for a lightweight, low cost product, it is possible to produce the matable pieces from other materials.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A device for retaining an electrical cord on an exterior of a motor vehicle, the device comprising:
a first shell piece having a first inner side, a first outer side facing opposite the first inner side, and a first channel recessed into the first shell piece from the first inner side and extending through opposite ends of the first shell piece; and
a second shell piece having a first inner side, a second outer side facing opposite the first inner side, and a second channel recessed into the second shell piece from the second inner side and extending through opposite ends of the second shell piece, the first and second inner sides being cooperatively shaped to enable fitting of the first and second shell pieces together against one another at the first and second inner sides with the first and second channels aligned and open to one another to collectively form a resulting passage extending through the opposite ends of the first and second pieces when fitted together;
a fastener operable to secure the first and second shell pieces together when fitted against one another at the first and second inner sides with the first and second channels aligned; and
a securing element attached to the first shell piece and operable to releasably secure the first shell piece to the exterior of the motor vehicle to retain the electrical cord thereon once the shell pieces are fitted and fastened together with a portion of the electrical cable running between the shell pieces in the passage formed by the first and second channels.

2. The device of claim 1 wherein the securing element comprises a magnet.

3. The device of claim 1 wherein the fastener comprises a snap fit fastener having matable elements defined on opposing ones of the first and second shell pieces.

4. The device of claim 1 wherein the first and second channels each taper in diameter moving inward from the opposite ends of the first and second shell pieces respectively.

5. The device of claim 1 further comprising a sleeve fittable onto the portion of the cable to close therearound prior to fastening together of the shell pieces around the portion of the cable, the sleeve being fittable within the passage formed by the channels with the shell pieces fastened together in a secured but rotatable manner allowing rotation of the sleeve within the passage but preventing sliding of the sleeve device out from the passage.

6. The device of claim 5 wherein the sleeve comprises at least one enlarged portion of greater outer diameter than a smaller diameter portion of the sleeve and the channels have channel portions of smaller radius that align with one another when the shell pieces are fastened together to define a smaller portion of the passage in which the enlarged portion of the sleeve cannot be accommodated.

7. The device of claim 6 wherein the at least one enlarged portion comprises opposing end portions of the sleeve too large to pass through respective end portions of the channels.

8. The device of claim 6 wherein the channels have corresponding enlarged portions that are of greater radius than the smaller radius portions of the channels and that align with one another when the shell pieces are fastened together to define an enlarged receiving portion of the passage, the enlarged portion of the sleeve being sized to fit within the enlarged receiving portion of the passage but not within the smaller portions of the passage.

9. The device of claim 5 wherein the sleeve comprises at least one interior projection formed at a boundary wall of an interior bore of the sleeve and projecting into the interior bore from the boundary wall.

10. The device of claim 1 comprising at least one projection formed at a bottom of the first or second channel to extend away from the bottom toward the first or second inner side respectively.

11. The device of claim 1 wherein the shell pieces are shaped to, when fastened together, define a gripping feature that, relative to a contact surface of the first outer side that is intended to be secured to the vehicle, projects outward from said contact surface at a distance therefrom in a direction that separates the first inner side from the second inner side.

12. The device of claim 1 in combination with the electrical cord and the vehicle, the shell pieces being fastened together across the electrical cord to enclose the portion thereof between the shell pieces in the passage collectively defined by the channels thereof, wherein the electrical cord extends from proximate a front end of an engine compartment of the vehicle to a side of the vehicle where the portion of the electrical cord is retained in the device on a panel of the vehicle by the securing element.

13. The device of claim 12 wherein the electrical cord, from the device, continues away from the front end of the engine compartment and wraps around a side mirror of the vehicle.

14. The device of claim 1 in combination with the electrical cord and the vehicle, the shell pieces being fastened together across the electrical cord to enclose the portion thereof between the shell pieces in the passage collectively defined by the channels thereof, wherein the electrical cord extends from proximate a front end of an engine compartment of the vehicle to a position on a hood of the vehicle overlying the engine compartment, where the portion of the electrical cord is retained in the device on the hood of the vehicle by the securing element.

15. A method of retaining an electrical cord on a motor vehicle, the method comprising:
(a) at one or more locations along the electrical cord between opposing ends thereof, fastening a respective pair of shell pieces together from opposite sides of the electrical cord to enclose a respective portion of the electrical cord between the respective pair of shell pieces and thereby secure the respective fastened together pair of shell pieces to the electrical cord; and
(b) releasably securing each pair of fastened together shell pieces to an exterior of the vehicle at a respective location thereon to secure the respective portion of the electrical cord housed between the respective fastened together pair shell pieces to the exterior of the vehicle.

16. The method of claim 15 wherein step (b) comprises securing at least one pair of fastened together shell pieces to a body panel at a side of the vehicle.

17. The method of claim 16 comprising wrapping part of the electrical cord about a side mirror of the vehicle.

18. The method of claim 17 wherein the part of the electrical cord wrapped about the side mirror of the vehicle does not include either of the opposing ends of the electrical cord, the wrapping of the electrical cord about the side mirror acting to change a direction in which the electrical cord extends along the side of the vehicle between the opposing ends of the electrical cord.

19. The method of claim 15 wherein step (b) comprises securing at least one pair of fastened together shell pieces to a hood of the vehicle.

20. The method of claim 15 wherein step (b) comprises magnetically securing at least one pair of fastened together shell pieces to the vehicle at the exterior thereof.
